(19) United States
(12) Patent Application Publication
(10) Pub. No.: US 2015/0143103 A1
(43) Pub. Date: May 21, 2015

(54) MESSAGING AND NETWORKING KEEPSAKES

(71) Applicant: Life of Two, Inc., San Francisco, CA (US)

(72) Inventors: Roman Weishaupl, San Francisco, CA (US); Bianca Weishaupl, San Francisco, CA (US)

(73) Assignee: Life of Two, San Francisco, CA (US)

(21) Appl. No.: 14/083,026

(22) Filed: Nov. 18, 2013

(51) Int. Cl. H04L 29/08; H04L 29/06

(52) U.S. Cl. CPC H04L 67/10; H04L 63/0428
USPC 713/153; 709/203

(57) ABSTRACT

Disclosed herein are systems, methods, and non-transitory computer-readable storage media for allowing parties exchanging digital objects and members of social networks to catalog certain data objects as favorites in a cataloged interface and which allow the parties to access and interact with the catalog of favorited content.

### BACKGROUND

1. Technical Field

The present disclosure relates to memorializing data objects and more specifically to memorializing data objects in messaging and networking applications.

2. Introduction

For many, email, instant messaging, and social networking have become everyday forms of communication. Indeed, the rapid adoption of smartphone usage has increased the use of these digital communication means such that their use is nearly ubiquitous in many communities.

Despite the popularity of these forms of communication, techniques for memorializing important, sentimental, or otherwise special communications are lacking. Adequate solutions do not exist for distinguishing special messages and posts from mundane communications. Similarly, there are not sufficient techniques for allowing users to go back through past messages to re-visit all of the special, sentimental social networking posts without also seeing the mundane or negative content.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

As used herein, the terms “favorite” and “like” can be used as verbs whose infinitive can means to indicate content as being subjectively pleasing, unique, special, etc. Similarly, “favorited” or “liked” can be used an adjective to describe something that has been indicated as subjectively pleasing, unique, special, etc. Also, the term “data objects” can include instant messages, text messages, blog posts, micro blog posts, status updates, articles, documents, advertisements, photos, videos, music files, animations, etc.

Disclosed are systems, methods, and non-transitory computer-readable storage media for allowing parties who exchange data objects and members of social networks to catalog certain data objects as favorites in a cataloged interface and which allow the parties to access and interact with the catalog of favorited content.

In some embodiments of the present technology, a messaging platform is configured to allow users to favorite certain messages and to access favorited content in a keepsake view interface. In some embodiments, the messaging platform is especially configured for couples to share a variety of communications and to allow the couples to mark special or sentimental communications as a favorite to distinguish them from mundane communications. The favorited messages can be accessed in a keepsake view interface that allows the couple to re-visit memories.

In some embodiments of the present technology, a social networking platform can memorialize affinity data for data objects that are liked by a user's network connections and can display the liked content to the user in an affinity view interface. Similarly, in some embodiments, the social networking platform can collect affinity information for content posted by other members of a user's social network and liked by a user and display the content subject to the user's affinity in an affinity view interface. In some embodiments of the present technology, an application aggregates a plurality of data object feeds from a plurality of social networking platforms associated with a user and provides an aggregated affinity view interface for all content liked by the user across all of the platforms.

Some embodiments of the present technology involve a method of synchronizing a keepsake view interface that includes directing data objects between a first user account and a second user account, receiving an instruction from a user to mark particular data objects as favorites, and memorializing the favorited data objects in a keepsake view interface that can be accessed by both users. In some embodiments, either the first user or the second user can request to remove a favorited object from the keepsake view interface.

In some embodiments the method involves encrypting the data objects at the server, saving an encrypted version of the data objects in a cloud-based storage platform, and providing the first user account and the second user account with a key for accessing the encrypted version of the data object.

In some embodiments, the method involves post-favoriting activities such as re-sending the data objects to the users on an anniversary of the timestamp or periodically creating a journal of favorited data objects from the keepsake view interface.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A illustrates a graphical user interface of a messaging application according to some embodiments of the present technology;

FIG. 1B illustrates the graphical user interface with a highlighted icon according to some embodiments of the present technology;

FIG. 1C illustrates photos sent between parties in a messaging application with a photo being marked as a favorite;

FIG. 1D illustrates an exemplary menu according to come embodiments of the present technology;

FIG. 1E illustrates a Keepsake View Interface according to some embodiments of the present technology;

FIG. 2 illustrates a system for creating a shared keepsake view of favorite content according to some embodiments of the present technology;

FIG. 3 illustrates an exemplary method of providing keepsake content to parties of a messaging application according to some embodiments of the present technology;

FIG. 4 illustrates an exemplary social media environment configured for providing enhanced favorited, liked, and other preference data according to some embodiments of the present technology;

FIG. 5 illustrates a networking aggregation application with a Keepsake feature according to some embodiments of the present technology; and

FIG. 6A and FIG. 6B illustrate exemplary possible system embodiments.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

A system, method and non-transitory computer-readable media are disclosed which allow parties exchanging digital messages and members of social networks to catalog certain messages, posts, etc. as “favorites” or as “liked” and which allow the parties to access and interact with the catalogs of favorited or liked digital objects.

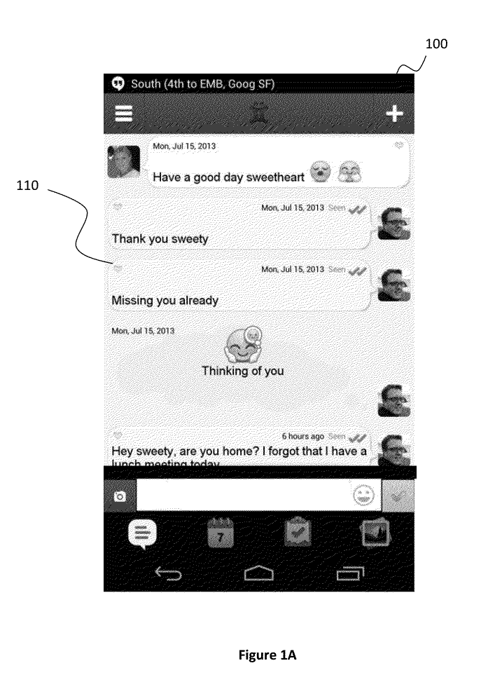

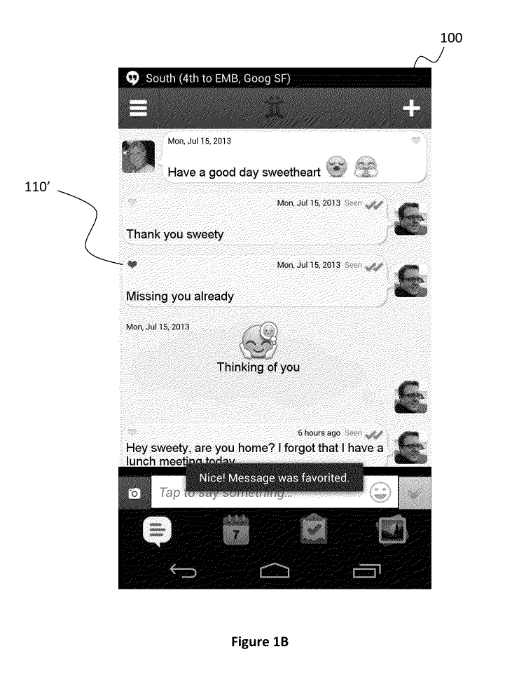

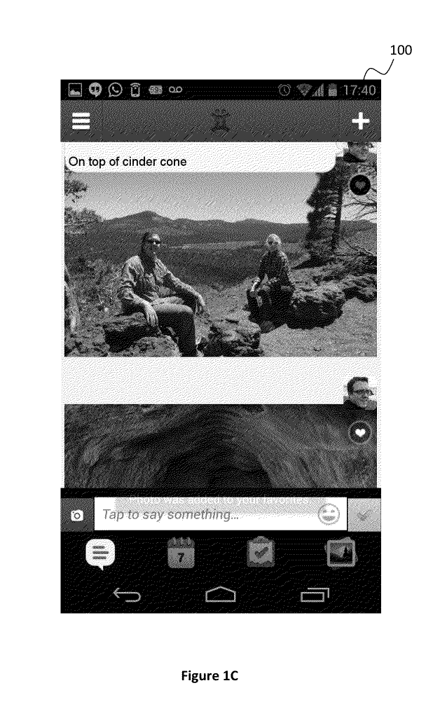

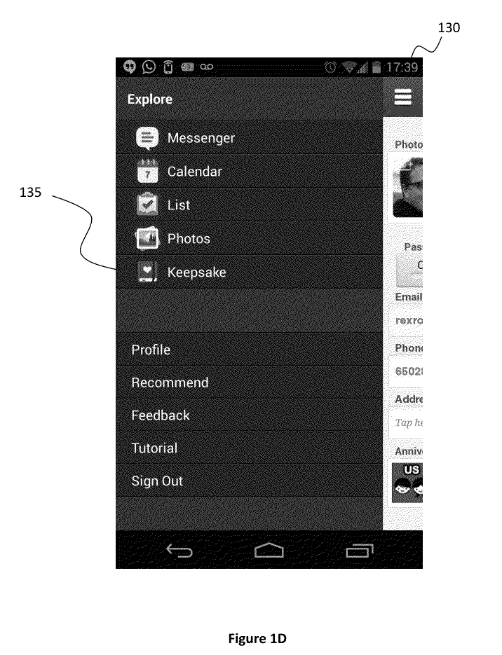

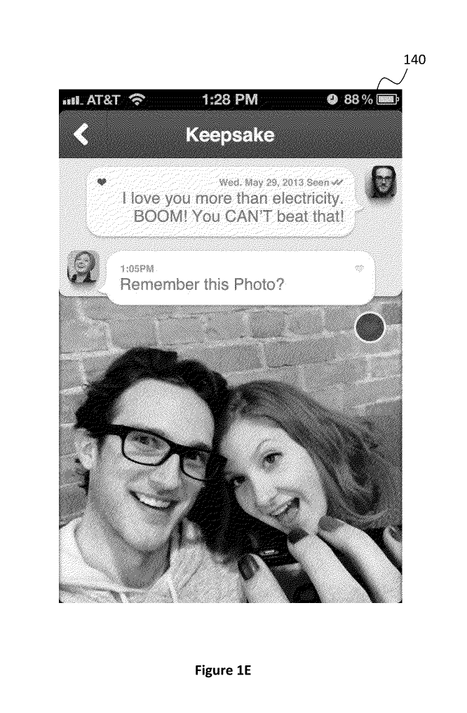

FIG. 1A illustrates a graphical user interface (GUI) 100 of a messaging application according to some embodiments of the present technology. The interface 100 shows a chronological series of messages sent back and forth between two parties. The messages shown in FIG. 1A include text and emoticons; however, those with ordinary skill in the art having the benefit of this disclosure will readily appreciate that a wide variety of digital objects can be exchanged over the messaging application including photos, videos, music files, animations, blog posts, documents, etc. As shown in FIG. 1A, some messages can include an interactive icon 110 that can be highlighted with a mouse click, one or more screen taps, a voice command, etc. to catalog the message in a list of favorited content.

FIG. 1B illustrates the graphical user interface 100 with a highlighted icon 110′ according to some embodiments of the present technology. As shown in FIG. 1B, a message can appear to notify a user that a message, photo, etc. has been marked as a favorite. Similarly, FIG. 1C illustrates a graphical user interface (GUI) 120 of a messaging application with photos sent between parties in a messaging application with a photo being marked as a favorite.

In some embodiments of the present technology, the user interface 100 can include a menu icon 120 configured to access a menu of options, command, etc. FIG. 1D illustrates an exemplary menu 130 according to come embodiments of the present technology. As shown in FIG. 1D, the menu 130 includes a “Keepsake” menu item 135 that is configured to bring up a Keepsake View Interface. FIG. 1E illustrates a Keepsake View Interface 140 according to some embodiments of the present technology. The Keepsake View Interface 140 includes a catalog of all of the digital objects that have been marked as a favorite by either party using the messaging application. In some embodiments of the present technology, the messaging application can tag the favorited content with a time stamp and the Keepsake View Interface can display favorited content in a timeline view, or other time-based configurations (e.g. calendar view).

Previous messaging fall short in that they do not provide the sender a sense that the recipient found the message important. Accordingly, some embodiments of the present technology systems, methods and non-transitory computer-readable media that allows messaging and networking application to create a shared space that can include messages, photos, etc. marked as a favorite by any party.

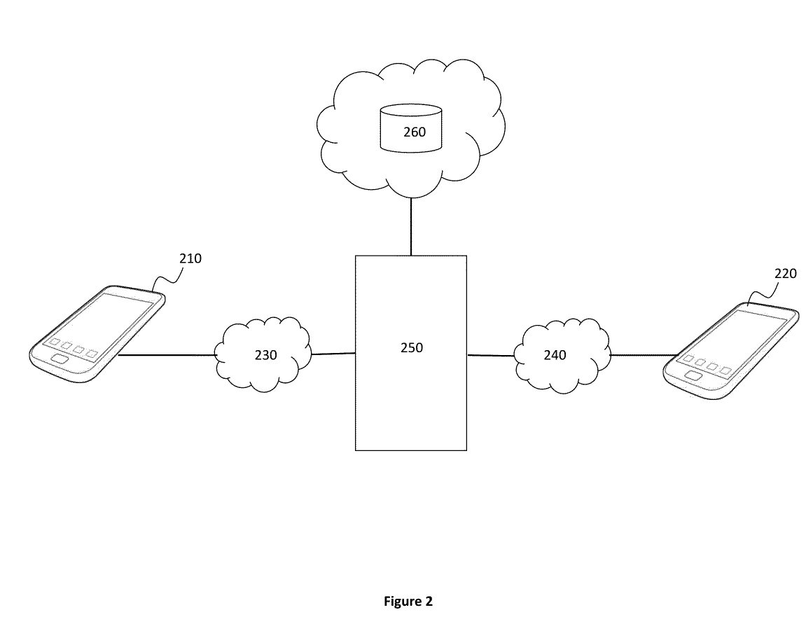

FIG. 2 illustrates a system for creating a shared keepsake view of favorite content according to some embodiments of the present technology. Two or more users can exchange digital objects (messages, photos, videos, blog posts, etc.) using an application operating on electronic devices 210, 220 over one or more network 230, 240 and by using a server 250. The server can be configured to encrypt the digital objects sent between the electronic devices 210, 220 and can be configured to store the encrypted objects locally or in a network-based storage facility 260.

As explained above, users can mark objects as favorites. Accordingly, the messaging application on the electronic devices 210, 220 can be configured to send signals to the server 250 that designate certain encrypted objects as favorites. After the server 250 receives a favorite signal, the server 250 can memorialize the favorited object and the other device that did not mark the message as a favorite can access a keepsake view of favorited objects. Additionally, the application can be configured to provide a keepsake view of favorite text messages, photos, videos, blog posts, etc. In some embodiments, while the keepsake view, users can also deny or remove the favorite designation (e.g. for an unflattering photo).

The application can be especially configured to allow couples to exchange messages and the favorite functions and the keepsake view can be used to separate sentimental messages, special photos, etc. from other mundane messages associated with domestic partnership (e.g. requests to pick up groceries).

Similarly, the application can be used for other groups of people (e.g. close circle of friends, teams, clubs, professional colleagues, organizations, etc.) for separating important content from mundane content, tedious administrative information, banter, etc.

In some embodiments, an application can be configured to perform other ancillary functions using the keepsake content. For example, an application can be configured to collect all of the favorited content over a predetermined period of time and automatically compile a digital scrapbook or photo journal that can be displayed on an electronic device or printed and delivered the users. The application can also be configured to automatically display favorited content to the users at certain time. For example, the application can be configured to send the users a message containing a favorited photo on anniversaries of the photo being taken. Also, in some embodiments of the present technology, the application can provide search functions for finding particular content in the keepsake view.

In some embodiments of the present technology, a messaging or networking application can automatically bunch content together when a user indicates a certain item as a favorite. For example, if a photo is sent between a couple and favorited by a member of the couple, the application can be configured to automatically favorite a message sent in response to receiving the photo, i.e. a reaction to the photo. In some embodiments, the application bunches content based on a temporal window around the transmission of an object that is favorited. In some embodiments, the messaging application queries the parties if they would like to have the application favorite other parts of a messaging session temporally near a favorited object.

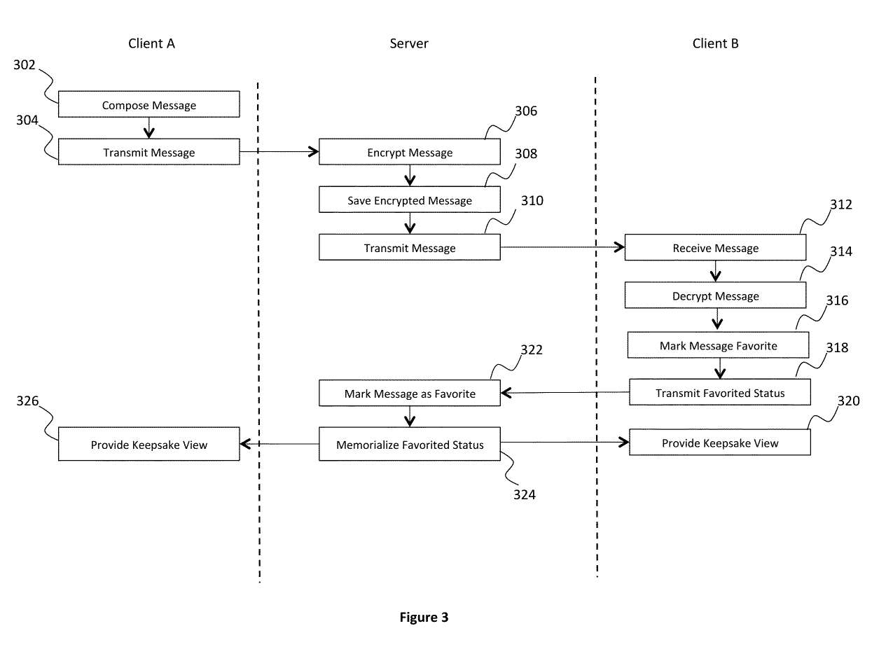

FIG. 3 illustrates an exemplary method 300 of providing keepsake content to parties of a messaging application according to some embodiments of the present technology. The method 300 begins with Client A composing a message 302 (e.g. text message, photo message, video message, status update, micro blog post, etc.) and transmitting the message 304. Next, the method involves the server receiving the message, encrypting the message 306, saving the encrypted message (e.g. in a cloud-based storage facility) 308, and transmitting the encrypted message 310 to Client B.

The method 300 continues with Client B receiving the encrypted message 312 and decrypting the message 314. Next, the method 300 can involve Client B marking the message as a favorite 316 and the messaging application transmitting a message's favorited status back to the server 318.

Subsequently, the method 300 can involve the server receiving the favorited status, marking the message as favorited 322, memorializing the favorited status for the message such that messages favorited both Client A and Client B can be provided in a keepsake view by both Client A 326 and Client B 320.

Some embodiments of the present technology involve pushing favorited, liked, and other kinds of preference data to users in a social media environment. As explained above, existing solutions allow a member of a social media network to indicate that the “like” another members post, photo, video, etc. However, users cannot conveniently see a history of cannot that they posted and another member (i.e. their partner or spouse) “liked,” view a catalog of content that both members of a relationship “like,” or search for “liked” content.

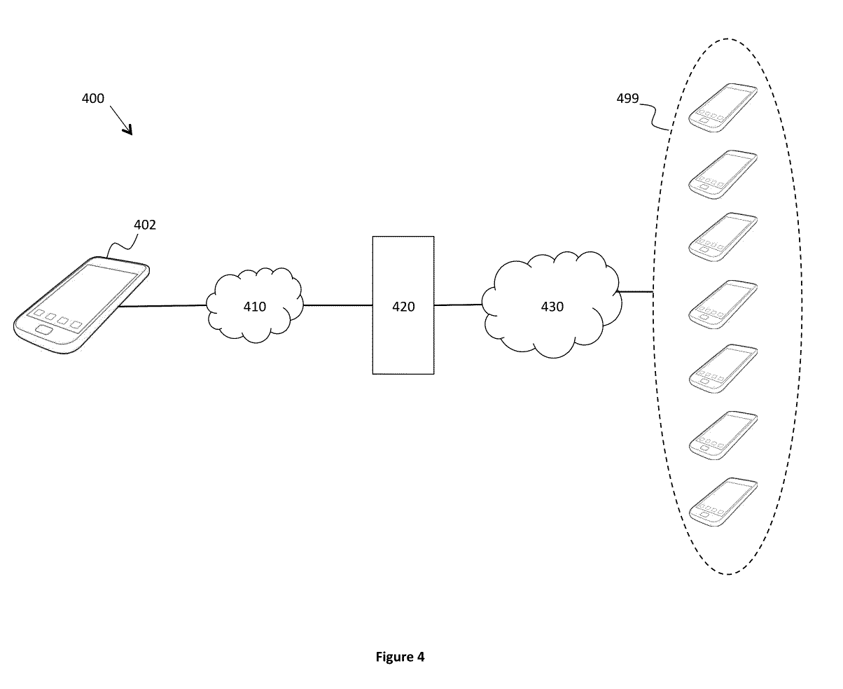

FIG. 4 illustrates an exemplary social media environment 400 configured for providing enhanced favorited, liked, and other preference data according to some embodiments of the present technology. As shown in FIG. 4, a user's client device 402 is coupled with a social media server 420 via a network 410. Additionally, the user is connected with a plurality of other users 499 connected to the social media server 420 via one or more network 430.

The user of the client device 402 and the other users 499 can post messages, photos, videos, blog posts, articles, etc., can view other user's posts, and indicate that various content is liked or is their favorite. Additionally, the social media server 420 can record a history of the users' preference data and provide extended functions including providing tools for searching liked content, displaying common liked data between a first user and another user (e.g. a friend), and displaying posts that a user uploaded and that another user (e.g. a spouse) liked. In these ways, users can revisit content that they previously liked or that they posted and another person liked.

Additionally, as social media networks grow in number and popularity, users can have a hard time keeping track of all of their online presences. Accordingly, some embodiments of the present technology involve a social media aggregation application that can be used to add posts from various feeds to one common Keepsake Feed. Likewise, the Keepsake Feed can be shared between users, such as spouses, close friends, clubs, etc.

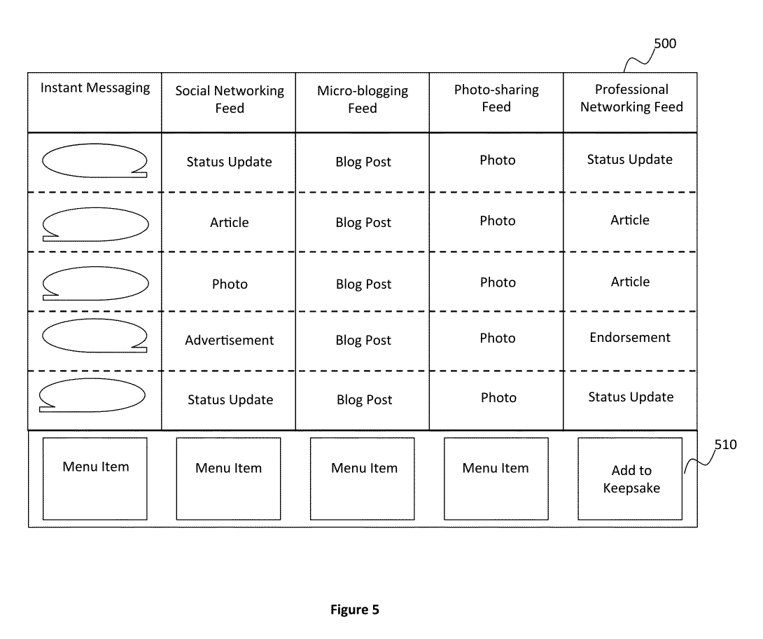

FIG. 5 illustrates a networking aggregation application 500 with a Keepsake feature according to some embodiments of the present technology. The networking aggregation application 500 involves feeds from a messaging service, a social media platform, a micro-blogging service, a photo-sharing service, and a professional networking platform. Each feed lists a plurality of posts, messages, photos, articles, blog entries, etc. Additionally, the networking aggregation application 500 includes a menu item 510 configured for adding one or more selected items to be stored as a keepsake. In some embodiments, a user individually stores keepsakes. In some embodiments, keepsakes are shared between users (e.g. couples).

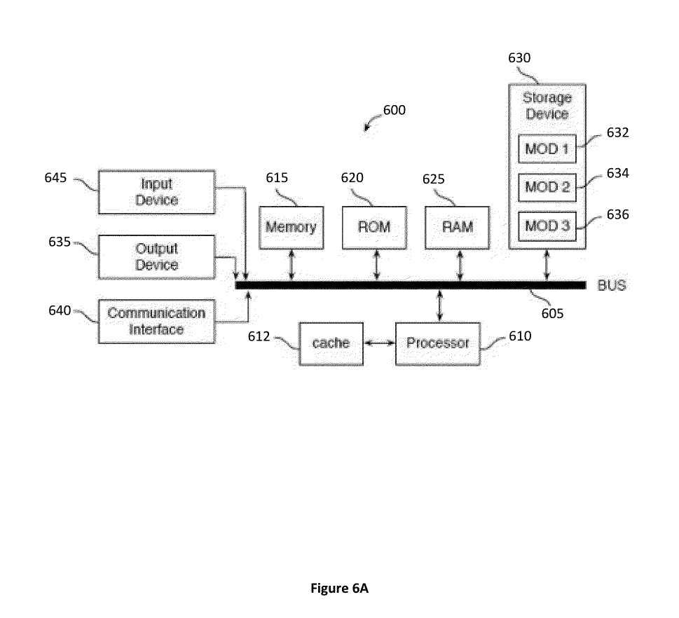

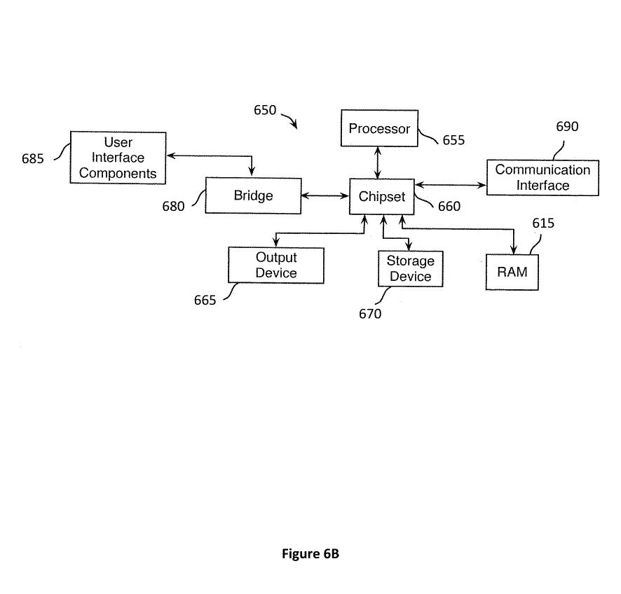

FIG. 6A and FIG. 6B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 6A illustrates a conventional system bus computing system architecture 600 wherein the components of the system are in electrical communication with each other using a bus 605. Exemplary system 600 includes a processing unit (CPU or processor) 610 and a system bus 605 that couples various system components including the system memory 615, such as read only memory (ROM) 620 and random access memory (RAM) 625, to the processor 610. The system 600 can include a cache of high-speed memory connected directly with, in close proximity to, or integrated as part of the processor 610. The system 600 can copy data from the memory 615 and/or the storage device 630 to the cache 612 for quick access by the processor 610. In this way, the cache can provide a performance boost that avoids processor 610 delays while waiting for data. These and other modules can control or be configured to control the processor 610 to perform various actions. Other system memory 615 may be available for use as well. The memory 615 can include multiple different types of memory with different performance characteristics. The processor 610 can include any general purpose processor and a hardware module or software module, such as module 1 632, module 2 634, and module 3 636 stored in storage device 630, configured to control the processor 610 as well as a special-purpose processor where software instructions are incorporated into the actual processor design. The processor 610 may essentially be a completely self-contained computing system, containing multiple cores or processors, a bus, memory controller, cache, etc. A multi-core processor may be symmetric or asymmetric.

To enable user interaction with the computing device 600, an input device 645 can represent any number of input mechanisms, such as a microphone for speech, a touch-sensitive screen for gesture or graphical input, keyboard, mouse, motion input, speech and so forth. An output device 635 can also be one or more of a number of output mechanisms known to those of skill in the art. In some instances, multimodal systems can enable a user to provide multiple types of input to communicate with the computing device 600. The communications interface 640 can generally govern and manage the user input and system output. There is no restriction on operating on any particular hardware arrangement and therefore the basic features here may easily be substituted for improved hardware or firmware arrangements as they are developed.

Storage device 630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 625, read only memory (ROM) 620, and hybrids thereof.

The storage device 630 can include software modules 632, 634, 636 for controlling the processor 610. Other hardware or software modules are contemplated. The storage device 630 can be connected to the system bus 605. In one aspect, a hardware module that performs a particular function can include the software component stored in a computer-readable medium in connection with the necessary hardware components, such as the processor 610, bus 605, display 635, and so forth, to carry out the function.

FIG. 6B illustrates a computer system 650 having a chipset architecture that can be used in executing the described method and generating and displaying a graphical user interface (GUI). Computer system 650 is an example of computer hardware, software, and firmware that can be used to implement the disclosed technology. System 650 can include a processor 655, representative of any number of physically and/or logically distinct resources capable of executing software, firmware, and hardware configured to perform identified computations. Processor 655 can communicate with a chipset 660 that can control input to and output from processor 655. In this example, chipset 660 outputs information to output 665, such as a display, and can read and write information to storage device 670, which can include magnetic media, and solid state media, for example. Chipset 660 can also read data from and write data to RAM 675. A bridge 680 for interfacing with a variety of user interface components 685 can be provided for interfacing with chipset 660. Such user interface components 685 can include a keyboard, a microphone, touch detection and processing circuitry, a pointing device, such as a mouse, and so on. In general, inputs to system 650 can come from any of a variety of sources, machine generated and/or human generated.

Chipset 660 can also interface with one or more communication interfaces 690 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 655 analyzing data stored in storage 670 or 675. Further, the machine can receive inputs from a user via user interface components 685 and execute appropriate functions, such as browsing functions by interpreting these inputs using processor 655.

It can be appreciated that exemplary systems 600 and 650 can have more than one processor 610 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A computer-implemented method of synchronizing a keepsake view interface comprising:
directing, through a server, a data object between a first user account and a second user account;
receiving, at the server, an instruction from a user associated with either the first user account or the second user account to mark the data object as a favorited data object; and
memorializing, by the server, a favorited status for the data object such that data objects favorited by a user associated with the first user account and data objects favorited by a user associated with the second user account are available in a keepsake view interface for both the user associated with the first user account and the user associated with the second user account.

2. The computer-implemented method of claim 1, wherein directing a data object between users of a first user account and a second user account further comprises encrypting the data object at the server.

3. The computer-implemented method of claim 2, wherein directing a data object between users of a first user account and a second user account further comprises:
saving an encrypted version of the data object in a cloud-based storage platform; and
providing the first user account and the second user account with a key for accessing the encrypted version of the data object.

4. The computer-implemented method of claim 3, wherein memorializing a favorited status for the data object comprises the server sending an instruction to the cloud-based storage platform to notate the data object with a favorited status.

5. The computer-implemented method of claim 1, further comprising:
receiving an instruction from any of the first user account and the second user account to remove the favorited status of a data object; and
removing the memorialized favorited status from the data object, thereby removing the data object from the keepsake view.

6. The computer-implemented method of claim 1, wherein data objects in the keepsake view interface include timestamps, the method further comprising:
re-sending the data object to the first user account and the second user account on an anniversary of the timestamp.

7. The computer-implemented method of claim 1, wherein data objects in the keepsake view interface include timestamps, the method further comprising:
collecting additional data objects directed between the first user account and the second user account having timestamps with predetermined degree of temporal closeness to the timestamp of the data object in the keepsake view;
including the additional data objects in the keepsake view.

8. The computer-implemented method of claim 1, further comprising:
compiling favorited data objects in the keepsake view interface; and
creating a journal displaying favorited data objects from the keepsake view interface.

9. A computer-implemented method of memorializing affinity data comprising:
linking, in a social networking server, a first user account with additional user accounts;
receiving a status update from the first user account;
creating a virtual space for presenting the status update to one or more of the additional user accounts;
receiving affinity information relating to the status update from the one or more additional user accounts;
memorializing the affinity information in the social networking server; and
providing an affinity view to the first user account for accessing affinity information from additional user account for status updates from the first user account.

10. A computer-implemented method of memorializing affinity data comprising:
linking, in a social networking server, a first user account with additional user accounts;
posting status updates from one or more of the additional user accounts on a virtual wall associated with the first user account
receiving affinity information relating to the status updates from the first user account;
memorializing the affinity information in the social networking server; and
providing an affinity view to the first user account for accessing status updates from additional user accounts that received affinity information by the first user account.

11. A computer-implemented method aggregating affinity data for networking applications comprising:
receiving, by a processor, credentials for a first networking application and an additional networking application;
receiving, from one or more networking servers, networking information from both the first networking application and the additional networking application;
displaying the networking information from both the first networking application and the additional networking application in a networking aggregation view interface;
receiving affinity information relating to one or more data object contained in the networking information; and
displaying an aggregated affinity view interface showing data objects relating to the affinity information received by both the first networking application the additional networking application.

12. A system for synchronizing a keepsake view interface comprising:
a server configured to:
direct a data object between a first user account and a second user account;
receive an instruction from a user associated with either the first user account or the second user account to mark the data object as a favorited data object; and
memorialize a favorited status for the data object such that data objects favorited by a user associated with the first user account and data objects favorited by a user associated with the second user account are available in a keepsake view interface for both the user associated with the first user account and the user associated with the second user account.

13. The system of claim 12, wherein the server is further configured to encrypt the data object before directing the data object between the first user account and the second user account;

14. The system of claim 13, further comprising:
a cloud-based storage platform operatively coupled with the server, wherein the server is further configured to:
save an encrypted version of the data object in the cloud-based storage platform; and
provide the first user account and the second user account with a key for accessing the encrypted version of the data object.

15. The system of claim 14, wherein the server is further configured to:
send an instruction to the cloud-based storage platform to notate the data object with a favorited status.

16. The system of claim 12, wherein the server is further configured to:
receive an instruction from any of the first user account and the second user account to remove the favorited status of a data object; and
remove the memorialized favorited status from the data object, thereby removing the data object from the keepsake view.

17. A non-transitory computer-readable storage medium comprising:
a medium configured to store computer-readable instructions thereon; and
the computer-readable instructions that, when executed by a processing device cause the processing device to perform a method of synchronizing a keepsake view interface, comprising:
directing, through a server, a data object between a first user account and a second user account;
receiving, at the server, an instruction from a user associated with either the first user account or the second user account to mark the data object as a favorited data object; and
memorializing, by the server, a favorited status for the data object such that data objects favorited by a user associated with the first user account and data objects favorited by a user associated with the second user account are available in a keepsake view interface for both the user associated with the first user account and the user associated with the second user account.

18. The non-transitory computer-readable storage medium of claim 17, wherein directing a data object between users of a first user account and a second user account further comprises encrypting the data object at the server.

19. The non-transitory computer-readable storage medium of claim 18, wherein directing a data object between users of a first user account and a second user account further comprises:
saving an encrypted version of the data object in a cloud-based storage platform; and
providing the first user account and the second user account with a key for accessing the encrypted version of the data object.

20. The non-transitory computer-readable storage medium of claim 19, wherein memorializing a favorited status for the data object comprises the server sending an instruction to the cloud-based storage platform to notate the data object with a favorited status.

21. The non-transitory computer-readable storage medium of claim 20, and the instructions further causing the processing device to perform the steps of:
receiving an instruction from any of the first user account and the second user account to remove the favorited status of a data object; and
removing the memorialized favorited status from the data object, thereby removing the data object from the keepsake view.
